(19) United States
(12) Patent Application Publication
(10) Pub. No.: US 2025/0284244 A1
(43) Pub. Date: Sep. 11, 2025

(54) SYSTEM AND METHOD FOR PHASE SPATIAL LIGHT MODAULTOR

(71) Applicant: TEXAS INSTRUMENTS INCORPORATED, Dallas, TX (US)

(72) Inventors: Andrew DEWA, Plano, TX (US); Terry A. Bartlett, Dallas, TX (US)

(21) Appl. No.: 18/599,203

(22) Filed: Mar. 8, 2024

(51) Int. Cl. G03H 1/22; G03H 1/08

(52) U.S. Cl. CPC G03H 1/2294; G03H 1/0808; G03H 2222/12; G03H 2225/32

(57) ABSTRACT

A system includes: a spatial light modulator (SLM) having a first array of pixels; a phase spatial light modulator (PSLM) optically coupled to and illuminating the SLM, the PSLM having a second array of pixels; and control circuitry coupled to the SLM and PSLM. The control circuitry is configured to: obtain a baseline hologram; determine sub-holograms for a plurality of brightness zones responsive to the baseline hologram and respective brightness zone transforms; combine the sub-holograms to produce a target hologram; provide the target hologram to the PSLM; and provide a control data to the SLM. The SLM is configured to adjust the first array of pixels responsive to the control data. The PSLM is configured to adjust the second array of pixels responsive to the target hologram.

### BACKGROUND

Modern projectors include a light source, a spatial light modulator (SLM), and a controller for the light source and the SLM. An example SLM may use pixels to change the angle of reflected light. Use of an additional phase spatial light modulator (PSLM) could enhance an image while adding control complexity. Computing the hologram for a PSLM in a high dynamic range (HDR) display or projector is computationally intensive. One PSLM and SLM control technique involves computing a hologram frame-by-frame using iterative Fourier transform analysis and scaling SLM pixel values based on the hologram, which would be expensive to implement, and may add frame delay.

### SUMMARY

In an example, a system comprises: a spatial light modulator (SLM) having a first array of pixels; a phase spatial light modulator (PSLM) optically coupled to and illuminating the SLM, the PSLM having a second array of pixels; and control circuitry coupled to the SLM and PSLM. The control circuitry is configured to: obtain a baseline hologram; determine sub-holograms for a plurality of brightness zones responsive to the baseline hologram and respective brightness zone transforms; combine the sub-holograms to produce a target hologram; provide the target hologram to the PSLM; and provide a control data to the SLM. The SLM is configured to adjust the first array of pixels responsive to the control data. The PSLM is configured to adjust the second array of pixels responsive to the target hologram.

In another example, a method comprises: determining, by control circuitry, sub-holograms for a plurality of brightness zones; combining, by the control circuitry, the sub-holograms to produce a target hologram; and transmitting, by the control circuitry, the target hologram.

In yet another example, a projector comprises: a PSLM having an array of pixels; and a controller coupled to the PSLM. The controller is configured to: obtain zone brightness data; obtain a baseline hologram; determine sub-holograms for a plurality of brightness zones responsive to the baseline hologram and the zone brightness data; combine the sub-holograms to produce a target hologram; and provide the target hologram to the PSLM, wherein the PSLM is configured to adjust the array of pixels based on the target hologram.

### BRIEF DESCRIPTION OF THE DRAWINGS

FIG. 1 is a diagram of a system in accordance with various examples.

FIG. 2 is a diagram of another system in accordance with various examples.

FIG. 3 is a diagram of a projector in accordance with various examples.

FIG. 4 is a diagram of transforming target brightness zones to a hologram image in accordance with various examples.

FIG. 5 is a diagram representing transformation of a baseline hologram to sub-holograms in accordance with various examples.

FIG. 6 is a diagram representing tiling of sub-holograms to form a target hologram in accordance with various examples.

FIG. 7 is a flowchart showing a phase spatial light modulator controller method in accordance with various examples.

FIG. 8 is a flowchart showing a projector control method in accordance with various examples.

FIG. 9 is a flowchart showing a projector method in accordance with various examples.

### DETAILED DESCRIPTION

The same reference numbers or other reference designators are used in the drawings to designate the same or similar features. Such features may be the same or similar either by function and/or structure.

In the described examples, a projector controller (sometimes just controller hereafter) provides controls signals for a light source, a phase spatial light modulator (PSLM), and a spatial light modulator (SLM). The controller may include one or more circuits. The circuits of the controller may be integrated circuits (ICs) or other circuits. In the described examples, the controller reduces the computational overhead (improving speed and/or bandwidth) of PSLM control compared to techniques that use real-time hologram computation, such as an iterative Fourier transform analysis, to determine the hologram used for PSLM control. In some examples, the controller is configured to: obtain a baseline hologram; determine a sub-hologram for each of a plurality of brightness zones responsive to the baseline hologram and respective brightness zone transforms; combine the sub-holograms to produce a target hologram; and provide the target hologram to the PSLM. The figures hereafter provide additional details and example systems, controllers, and control options.

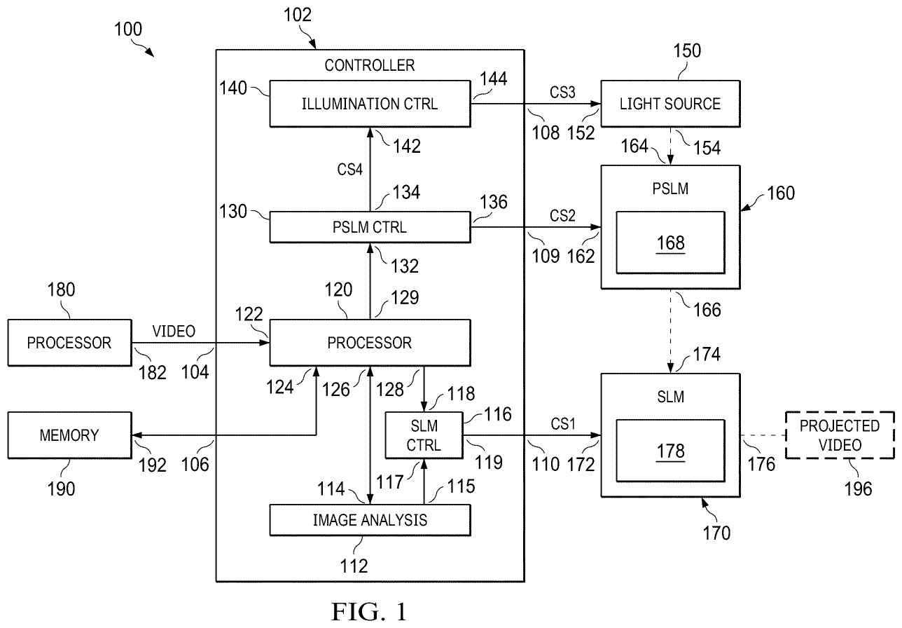

FIG. 1 is a diagram of a system 100 in accordance with various examples. In some examples, system 100 is a projector such as a traditional projector, an augmented reality (AR) display, a virtual reality (VR) display, a smart headlight, a heads-up display (HUD), an automotive ground projector, a 3D display, or another type of projector.

The example system 100 is not intended to be limiting and the control techniques described herein may be used in any other system to efficiently control a PSLM such as PSLM 160. As shown, system 100 includes a controller 102, a light source 150, the PSLM 160, an SLM 170, a processor 180, and a memory 190. The controller 102 has a first terminal 104, a second terminal 106, a third terminal 108, a fourth terminal 109, and a fifth terminal 110. The light source 150 has a terminal 152 and an optical output 154. The PSLM 160 has a terminal 162, an optical input 164, and an optical output 166. The SLM 170 has a terminal 172, an optical input 174, and an optical output 176. The processor 180 has a terminal 182. The memory 190 has a terminal 192.

In the example of FIG. 1, the PSLM 160 includes an array of pixels 168. In some examples, the array of pixels 168 may include mechanical elements, electro-optical elements, thermo-optical elements, magneto-optical elements, microelectromechanical system (MEMS) elements, and related control elements (e.g., an array of memory cells). In some examples, the PSLM 160 is a phase light modulator (PLM) having pixels 168 that are micromirrors having adjustable heights to affect the phase of light. In another example the PSLM 160 is a ferroelectric liquid crystal on silicon (FLCoS) device having pixels 168 that affect the phase of light.

In the example of FIG. 1, the controller 102 includes a processor 120, image analysis circuitry 112, SLM control circuitry 116, PSLM control circuitry 130, and illumination control circuitry 140. The processor 120 has a first terminal 122, a second terminal 124, a third terminal 126, a fourth terminal 128, and a fifth terminal 129. The image analysis circuitry 112 has a first terminal 114 and a second terminal 115. The SLM control circuitry 116 has a first terminal 117, a second terminal 118, and a third terminal 119. The PSLM control circuitry 130 has a first terminal 132, a second terminal 134, and a third terminal 136. The illumination control circuitry 140 has a first terminal 142 and a second terminal 144.

As shown, the first terminal 104 of the controller 102 is coupled to the terminal 182 of the processor 180. The second terminal 106 of the controller 102 is coupled to the terminal 192 of the memory 190. As another option, the processor 180 and the memory 190 may be coupled together and are in communication with the controller 102 and the processor 120 via a single interface. The third terminal 108 of the controller 102 is coupled to the terminal 152 of the light source 150. The fourth terminal 109 of the controller 102 is coupled to the terminal 162 of the PSLM 160. The fifth terminal 110 of the controller 102 is coupled to the terminal 172 of the SLM 170. The optical output 154 of the light source 150 is optically coupled to the optical input 164 of the PSLM 160. The optical output 166 of the PSLM is optically coupled to the optical input 174 of the SLM 170. The optical output 176 of the SLM 170 provides projected video 196.

As shown, the first terminal 122 of the processor 120 is coupled to the first terminal 104 of the controller 102. The second terminal 124 of the processor 120 is coupled to the second terminal 106 of the controller 102. The third terminal 126 of the processor 120 is coupled to the first terminal 114 of the image analysis circuitry 112. The fourth terminal 128 of the processor 120 is coupled to the second terminal 118 of the SLM control circuitry 116. The fifth terminal 129 of the processor 120 is coupled to the first terminal 132 of the PSLM control circuitry 130. The second terminal 134 of the PSLM control circuitry is coupled to the first terminal 142 of the illumination control circuitry 140. The third terminal 136 of the PSLM control circuitry 130 is coupled to the fourth terminal 109 of the controller 102. The second terminal 144 of the illumination control circuitry 140 is coupled to the third terminal 108 of the controller 102. The second terminal 115 of the image analysis circuitry 112 is coupled to the first terminal 117 of the SLM control circuitry 116. The third terminal 119 of the SLM control circuitry 116 is coupled to the fifth terminal 110 of the controller 102.

In some examples, the processor 180 can be a central processing unit (CPU), a graphics processing unit (GPU), or a specialized processor programmed to perform image compression or decompression operations. In different examples, the processor 180 may include a processing pipeline, buffering, and control logic for performing image compression or decompression operations. Also, the processor 180 may include multiple processors, controllers, or engines to perform image compression or decompression operations. In one example, the processor 180 uses buffering and logic with a pipelined data path architecture to perform the image compression or decompression operations. Interleaving blocks in a single pipeline can present some limitations, as the single pipeline becomes a bandwidth bottleneck. Duplicating the pipeline increases bandwidth, but at the cost of logic area. In an example, the processing, buffering, and control logic are bundled into an image compression or decompression engine. A processing system may include multiple processing engines. The number of processing engines and an interleaving factor can be varied to ensure that an available compression bandwidth is in line with the compression bandwidth used by the compression tasks being performed. As used herein, “interleaving factor” refers to the number of processing queues and related stages of pipelined hardware for a processing engine. When queuing blocks of an image for compression operations, multiple blocks of the image are processed through different stages of the pipelined hardware of a processing engine in a manner that reduces the amount of waiting time for each processing stage and improves the overall processing speed relative to processing one block at a time. In one example, eight processing engines could be used, with each processing engine interleaving 32 blocks. In this example, the interleaving factor is 32. In other examples, the number of processing engines and the interleaving factor may vary. Without limitation, the number of processing engines may be two, four, six, eight, ten, or another integer number of processing engines. Without limitation, the interleaving factor may be two, four, eight, sixteen, or another integer number.

In some examples, the memory 190 may include read-only-memory (ROM), random access memory (RAM), electrically erasable programmable read-only memory (EEPROM), flash memory, and/or other non-transitory computer readable memory types. In different examples, the memory 190 may correspond to a single memory unit or multiple memory units. In some examples, the memory 190 stores configuration parameters for use by the controller 102.

In some examples, the controller 102 operates to: receive video data from the processor 180 at the first terminal 104; receive configuration data from the memory 190 at the second terminal 106; provide first control signals (CS1) for the SLM 170 at the fifth terminal 110 responsive to the video data, the configuration data, operations of the image analysis circuitry 112, operations of the processor 120, and/or operations of the SLM control circuitry 116; provide second control signals (CS2) for the PSLM at the fourth terminal 109 responsive to the video data, the configuration data, operations of the image analysis circuitry 112, operations of the processor 120, and/or operations of the PSLM control circuitry 130; and provide third control signals (CS3) for the light source 150 at the third terminal 108 responsive to the video data, the configuration data, operations of the image analysis circuitry 112, operations of the processor 120, operations of the PSLM control circuitry 130, and/or operations of the illumination control circuitry 140.

In some examples, the controller 102 is configured to provide CS3 to control the light source 150, provide CS2 to control the PSLM 160, and provide CS1 to control the SLM 170. The control of the light source 150, the PSLM 160, and the SLM 170 by the controller 102 results in the projected video 196. In some examples, the SLM 170 creates the image for the projected video 196 based on CS1, the PSLM 160 control brightness zones of the projected video 196 based on CS2, and the light source 150 controls illumination on-time and illumination off-time intervals based on CS3. Together, the SLM 170, the PSLM 160, and the light source 150 control dynamic range and colors of the projected video 196.

In some examples, the image analysis circuitry 112 may include hardware accelerators or a processor configured to perform image analysis and compare determined image attribute metrics to related thresholds. To prevent lag, image analysis circuitry 112 performs operations at a rate that enables per frame analysis. As another option, the image analysis circuitry 112 may skip analysis of some frames (e.g., skipping every other frame or skipping further analysis of frames responsive to a similarity metric). Based on the image analysis and related metrics, the image analysis circuitry 112 determines image analysis results. In some examples, the image analysis circuitry 112 determines zone brightness data responsive to the image analysis results.

In some examples, the processor 120 may include one or more processor cores or engines configured to: receive video data at the first terminal 122; receive configuration data at the second terminal 124; provide configuration control signals at the third terminal 126 responsive to the configuration data; receive image analysis results from the image analysis circuitry 112 at the third terminal 126; provide pixel data at the fourth terminal 128 responsive to the video data, configuration data, and/or image analysis results; and provide zone brightness data at the fifth terminal 129 responsive to the video data, configuration data, and/or image analysis results. In some examples, the processor 120 may perform the operations of the image analysis circuitry 112. In some examples, the processor 120 may include one or more processor cores or engines configured to adjust or limit operations of the image analysis circuitry 112, the SLM control circuitry 116, the PSLM control circuitry 130, and/or the illumination control circuitry 140 responsive to user preferences or other configuration options. Example configuration or user preference options may include limiting or prioritizing the image attribute metrics to be used by the image analysis circuitry 112, adjusting thresholds to be used by the image analysis circuitry 112, limiting or adjusting control sequence options available for use by the SLM control circuitry 116, limiting or adjusting brightness zone options available for use by the PSLM control circuitry 130, adjusting the baseline hologram or selecting from different baseline hologram options for use by the PSLM control circuitry 130. Example configuration or user preference options may also account for configuration or user preference options such as color preferences or adjustments, power efficiency options, display frame rate adjustments, and/or other configuration or user preference options.

In some examples, the SLM control circuitry 116 may include hardware accelerators configured to: receive image analysis results at the first terminal 117; receive pixel data and/or configuration data at the second terminal 118; and produce CS1 at the third terminal 119 responsive to the image analysis results, the pixel data, and/or the configuration data. In some examples, CS1 includes control signals to control pixels 178 of the SLM 170. In some examples, CS1 is synchronized with CS2 and/or CS3 to synchronize operations of the SLM 170, the light source 150, and/or the PSLM 160.

In some examples, the PSLM control circuitry 130 is a field-programmable gate array (FPGA) or other programmable logic. In some examples, the PSLM control circuitry 130 operates to: receive zone brightness data at the first terminal 132 responsive to image analysis results; obtain a baseline hologram; determine a sub-hologram for each of a plurality of brightness zones indicated by the zone brightness data responsive to the baseline hologram and respective brightness zone transforms; combine the sub-holograms to produce a target hologram; and provide CS2 at the third terminal 136, where CS2 includes the target hologram. In some examples, CS2 includes the target hologram. In some examples, the target hologram includes a multi-bit value for each of the pixel 168 to control a respective mirror position (e.g., height). In some examples, the zone brightness data provided to the PSLM control circuitry 130 is determined by the image analysis circuitry 112 responsive to image analysis results. In other examples, the zone brightness data provided to the PSLM control circuitry 130 is determined by the processor 120 responsive to image analysis results. In some examples, CS2 is synchronized with CS1 and/or CS3 to synchronize operations of the SLM 170, the light source 150, and/or the PSLM 160.

In the example of FIG. 1, the PSLM control circuitry 130 is also configured to provide control signals (CS4) at the second terminal 134 to the illumination control circuitry 140 responsive to a target lighting configuration determined for the target hologram. In some examples, CS4 may include lighting configuration data for each color controlled by the illumination control circuitry 140.

In some examples, the illumination control circuitry 140 operates to: receive CS4 at the first terminal 142; and provide CS3 at the second terminal 144 responsive to CS4. CS3 may include control voltages for each color controlled by the light source 150. In some examples, CS3 includes control voltages for red, green, and blue colors controlled by the light source 150. In some examples, CS3 is synchronized with CS1 and/or CS2 to synchronize operations of the SLM 170, the light source 150, and/or the PSLM 160.

In some examples, the image analysis circuitry 112, the SLM control circuitry 116, the PSLM control circuitry 130, and the processor 120, and the illumination control circuitry 140 operate at a rate that enables image analysis, brightness zone generation, target hologram generation, control sequence selection/generation, generation of CS1, CS2, and CS3, and accounting for configuration and user preference options to be completed for each image frame. In such examples, the individual and combined operations of the image analysis circuitry 112, the processor 120, the SLM control circuitry 116, the PSLM control circuitry 130, and the illumination control circuitry 140 are performed within an interval determined by the target display frame rate. In some examples, configuration or user preference adjustments may be performed at another rate or upon request.

In some examples, the light source 150 provides light responsive to CS3. The light source 150 may include one or more lasers or other light sources. In some examples, the light source 150 may separately control the intensity of red light, the intensity of green light, and the intensity of blue light for each image frame responsive to CS3.

In some examples, the PSLM 160 may perform phase spatial modulation of light responsive to CS2 using mechanical, electro-optical, thermo-optical, and/or magneto-optical, and/or MEMS control options. In one example, the PSLM 160 is a PLM having MEMS mirrors with adjustable heights, where the height of the mirrors affects the phase of the light. In another example, the PSLM 160 is an FLCoS in which a voltage applied to a cell affects the phase of light. In some examples, CS2 includes a hologram. A hologram is an image formed by the interference of light from a coherent light source. In a hologram, pixel values are sent to pixels of the PSLM 160, and the pixel values. The PSLM 160 alters the coherent, for example laser, wavefront using interference to create a target image that is different than the pixel values. The PSLM 160 produces a target image at the SLM 170 based on light from the light source 150 and pixel values of the PSLM 160.

In some examples, the SLM 170 may perform spatial modulation of light responsive to CS1 using mechanical, electro-optical, thermo-optical, magneto-optical, and/or MEMS control options. Examples of the SLM 170 include, but are not limited to, a DMD, a LCoS device, or a liquid crystal display device.

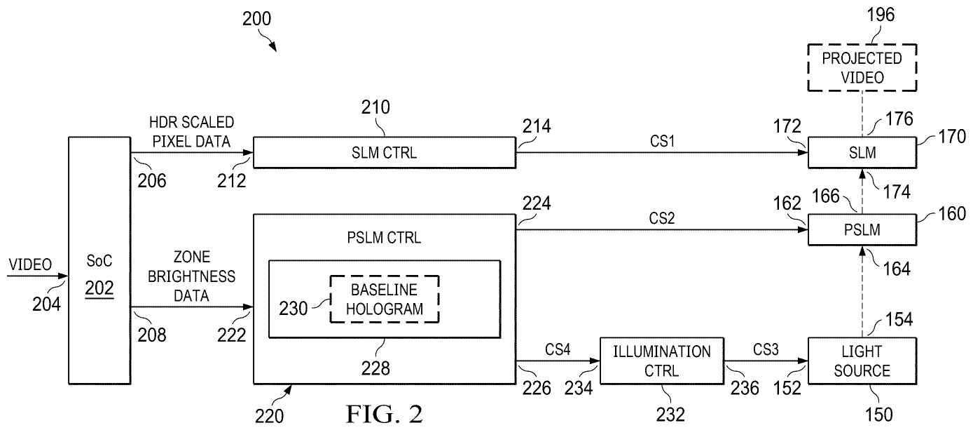

FIG. 2 is a diagram of another system 200 in accordance with various examples. In some examples, system 200 is a projector such as a traditional projector, an AR display, a VR display, a smart headlight, an HUD, a 3D display, or another type of projector.

The example system 200 is not intended to be limiting and the control techniques described herein may be used in any other system to efficiently control a PSLM such as the PSLM 160. As shown, the system 200 includes a system-on-a-chip (SoC) 202, SLM control circuitry 210, PSLM control circuitry 220, illumination control circuitry 232, the light source 150, the PSLM 160, and the SLM 170. The SoC 202 has a first terminal 204, a second terminal 206, and a third terminal 208. The SLM control circuitry 210 has a first terminal 212 and a second terminal 214. The PSLM control circuitry 220 has a first terminal 222, a second terminal 224, and a third terminal 226. The illumination control circuitry 232 has a first terminal 234 and a second terminal 236. The light source 150 has the terminal 152 and the optical output 154. The PSLM 160 has the terminal 162, the optical input 164, and the optical output 166. The SLM 170 has the terminal 172, the optical input 174, and the optical output 176.

The first terminal 204 of the SoC 202 is adapted to receive video data. The second terminal 206 of the SoC 202 is coupled to the first terminal 212 of the SLM control circuitry 210. The third terminal 208 of the SoC 202 is coupled to the first terminal 222 of the PSLM control circuitry 220. The second terminal 214 of the SLM control circuitry 210 is coupled to the terminal 172 of the SLM 170. The second terminal 224 of the PSLM control circuitry 220 is coupled to the terminal 162 of the PSLM 160. The third terminal 226 of the PSLM control circuitry 220 is coupled to the first terminal 234 of the illumination control circuitry 232. In the example of FIG. 2, the PSLM control circuitry 220 includes a memory 228. In some examples, the memory 228 stores a baseline hologram 230. The second terminal 236 of the illumination control circuitry 232 is coupled to the terminal 152 of the light source 150. The optical output 154 of the light source 150 is coupled to the optical input 164 of the PSLM. The optical output 166 of the PSLM 160 is coupled to the optical input 174 of the SLM 170. The optical output 176 of the SLM 170 provides the projected video 196.

In the example of FIG. 2, the SoC 202, the SLM control circuitry 210, the PSLM control circuitry 220, and the illumination control circuitry 232 perform the same or similar operations as the controller 102 of FIG. 1. More specifically, the SoC 202 may perform the same or similar operations as the processor 120 and the image analysis circuitry 112. The SLM control circuitry 210 may perform the same or similar operations as the SLM control circuitry 116. The PSLM control circuitry 220 may perform the same or similar operations as the PSLM control circuitry 130. The illumination control circuitry 232 may perform the same or similar operations as the illumination control circuitry 140.

In some examples, the SoC 202 operates to: receive video data at the first terminal 204; provide high dynamic range (HDR) scaled pixel data at the second terminal 206 responsive to the video data; and provide zone brightness data at the third terminal 208 responsive to the video data. In some examples, the SoC 202 provides pixel data including a multi-bit code for each of the pixels 178 of the SLM 170. If the bit depth of the pixel data from the SoC 202 matches the bit depth supported by the SLM 170, scaling of the pixel data from the SoC 202 may be avoided. In some examples, the SoC 202 can vary the number of bits for each multi-bit code. If the number of bits provided by the SoC 202 for each multi-bit code is at least a target number of bits, the pixel data is referred to as HDR scaled pixel data. In some examples, “zone brightness data” includes data that defines the number of zones, the position of zones, and a brightness level for each zone. In some examples, the SoC 202 may be an LCD flat panel SoC configured to determine zone brightness data responsive to video data. If the pixel data provided by the SoC 202 is not HDR scaled, the SLM control circuitry 210 may perform HDR scaling of the pixel data provided by the SoC 202.

In some examples, the SLM control circuitry 210 may include hardware accelerators configured to: receive pixel data at the first terminal 212; and produce CS1 at the second terminal 214 responsive to the pixel data. In some examples, the pixel data is HDR scaled pixel data and the SLM control circuitry 210 is configured to provided CS1 at the second terminal 214 responsive to the HDR scaled pixel data. In other examples, the pixel data is not HDR scaled pixel data. In such examples, the SLM control circuitry 210 is configured to: perform HDR scaling of the pixel data; and provide CS1 at the second terminal 214 responsive to the HDR scaled pixel data.

In some examples, the PSLM control circuitry 220 operates to: receive zone brightness data at the first terminal 222; obtain a baseline hologram; determine a sub-hologram for each of a plurality of brightness zones indicated by the zone brightness data responsive to the baseline hologram and respective brightness zone transforms; combine the sub-holograms to produce a target hologram; provide CS2 at second terminal 224, where CS2 includes the target hologram. In some examples, CS2 includes the target hologram and control voltages. The PSLM control circuitry 220 is also configured to provide CS4 at the third terminal 226 responsive to the zone brightness data and the target hologram.

In some examples, the illumination control circuitry 232 operates to: receive CS4 at the first terminal 234; and provide CS3 at the second terminal 236 responsive to CS4. CS3 may include control voltages for each color controlled by the light source 150. In some examples, CS3 includes control voltages for red, green, and blue colors controlled by the light source 150.

In some examples, the SoC 202, the SLM control circuitry 210, the PSLM control circuitry 220, and the illumination control circuitry 232 operate at a rate that enables image analysis, generation of zone brightness data, target hologram generation, control sequence selection/generation, generation of CS1, CS2, CS3, and accounting for configuration and user preference options to be completed for each image frame. In such examples, the individual and combined operations of the SoC 202, the SLM control circuitry 210, the PSLM control circuitry 220, and the illumination control circuitry 232 are performed within an interval determined by the target display frame rate. In some examples, configuration or user preference adjustments may be performed at another rate or upon request. In the example of FIG. 2, the light source 150, the PSLM 160, and the SLM 170 perform the same or similar operations as described in FIG. 1 to generate the projected video 196.

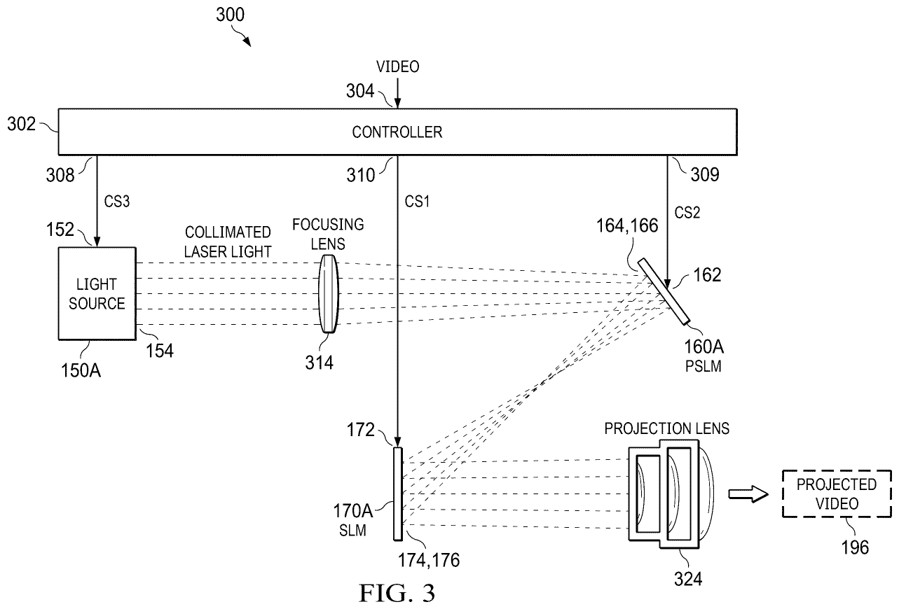

FIG. 3 is a diagram of a projector 300 in accordance with various examples. In some examples, the projector 300 may include some or all of the components of the system 100 or the system 200. As shown, the projector 300 includes a controller 302, a light source 150A, a focusing lens 314, a PSLM 160A, an SLM 170A, and a projection lens 324 in the arrangement shown. In some examples, the controller 302 is an example of the controller 102 in FIG. 1. In some examples, the controller 302 is an example of the controller 102 in FIG. 1. In some examples, the controller 302 includes the SoC 202, the SLM control circuitry 210, the PSLM control circuitry 220, and the illumination control circuitry 232 in FIG. 2.

As shown, the controller 302 has a first terminal 304, a second terminal 308, a third terminal 309, and a fourth terminal 310. The first terminal 304 of the controller 302 is an example of the first terminal 104 of the controller 102 in FIG. 1. The second terminal 308 of the controller 302 is an example of the third terminal 108 of the controller 102 in FIG. 1. The third terminal 309 of the controller 302 is an example of the fourth terminal 109 of the controller 102 in FIG. 1. The fourth terminal 310 of the controller 302 is an example of the fifth terminal 110 of the controller 102 in FIG. 1. The light source 150A has the terminal 152 and the optical output 154. The PSLM 160A has the terminal 162, the optical input 164, and the optical output 166. The SLM 170A has the terminal 172, the optical input 174, and the optical output 176.

In the example of FIG. 3, the controller 302 operates to: receive video data at the first terminal 304; provide CS1 at the fourth terminal 310 responsive to the video data; provide CS2 at the third terminal 309 responsive to the video data; and provide CS3 at the second terminal 308 responsive to the video data. In some examples, the controller operates to: generate zone brightness data responsive to video data or related image analysis results; obtain a baseline hologram; determine a sub-hologram for each of a plurality of brightness zones indicated by the zone brightness data responsive to the baseline hologram and respective brightness zone transforms; combine the sub-holograms to produce a target hologram; and provide CS2 at the third terminal 309, where CS2 includes the target hologram.

In the example of FIG. 3, the controller 302 operates to provide CS1, CS2, and CS3 responsive to the video data. The light source 150A operates to: receive CS3 at the terminal 152; and provide collimated laser light at the optical output 154 responsive to CS3. The focusing lens 314 operates to focus the collimated laser light. The PSLM 160A operates to: receive CS2 at the terminal 162; receive focused collimated laser light at the optical input 164; and reflect the focused collimated laser light at the optical output 166 responsive to CS2. The SLM 170A operates to: receive CS1 at the terminal 172; receive reflected light from the PSLM 160A at the optical input 174; and reflect light at the optical output 176 responsive to CS1. The projection lens 324 operates to: receive reflected light from the SLM 170A; and produce the projected video 196 responsive to the reflected light from the SLM 170A. In the example of FIG. 3, each of the SLM 170A and the PSLM 160A is reflective. In other examples, the PSLM 160A is reflective and the SLM 170A is transmissive. In other examples, the PSLM 160A is transmissive and the SLM 170A is reflective. In other examples, each of the SLM 170A and the PSLM 160A is transmissive. In different example, the orientation, spacing, and relative position of the light source 150A, the focusing lens 314, PSLM 160A, the SLM 170A, and the projection lens 324 may vary.

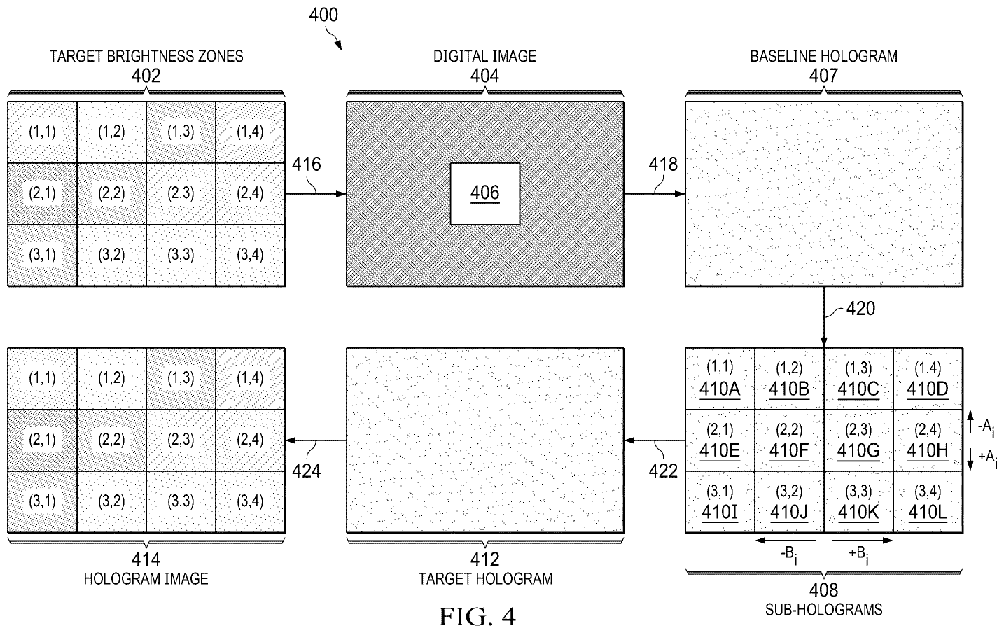

FIG. 4 is a diagram 400 of transforming target brightness zones 402 to a hologram image 414 in accordance with various examples. As shown, the diagram 400 includes the target brightness zones 402, a digital image 404, a baseline hologram 407, sub-holograms 408, a target hologram 412, the hologram image 414, and related operations 416, 418, 422, and 424. In some examples, the target brightness zones 402 may be defined by the zone brightness data described in FIGS. 1, 2, and 3. In some examples, the target brightness zones 402 define zone sizes, zone positions, and a brightness level for each zone based on video data or related image analysis results. In the example of FIG. 4, the target brightness zones 402 are organized as rows or columns of zones including a first row of zones (1,1) to (1,4), a second row of zones (2,1) to (2,4), and a third row of zones (3,1) to (3,4). In other examples, the image space, the zone sizes, the number of zone rows, and/or the number of zone columns may vary.

In some examples, the target brightness zones 402 are determined by performing image analysis as described herein. Example image analysis operations may account for predefined zones or selectable zones of an image. For each zone, an average local brightness or histogram is determined. The brightness level for the zone is then set based on the average local brightness or a histogram metric (e.g., an average value or other metric). In some examples, the target brightness zones 402 or related zone brightness data may be used to scale pixel data to account for the brightness zones. In some examples, such scaling may be relative to a maximum brightness level, which can be adjusted by a PSLM.

In some examples, the target brightness zones 402 or related parameters are used to obtain a digital image 404 based on the operation 416. In some examples, the number of zones and/or the size of zones for the target brightness zones 402 may be based on predetermined capabilities of an SoC (e.g., the SoC 202 in FIG. 2) or a processor (e.g., the processor in FIG. 1) that generates brightness zones. In other examples, the target brightness zones 402 may be based on a target projector specification, where an SoC (e.g., the SoC 202 in FIG. 2) or a processor (e.g., the processor in FIG. 1) is selected for its ability to support target brightness zones 402 that comply with the target projector specification. In some examples, the operation 416 may determine or obtain an image size and zone size based on the target brightness zones 402 or related parameters. In some examples, the digital image 404 includes a zone 406 with a target zone size that matches the size of each of the target brightness zones 402. The target zone size may be based on size parameters or the number of target brightness zones 402. In other examples, the digital image 404 may be a default digital image, where information or analysis of the target brightness zones 402 is not used. In such other examples, the target brightness zones 402 may be determined later and scaling operations may be used to account for the difference between a target zone size and a default or predetermined size of the zone 406.

In some examples, the digital image 404 is used to obtain a baseline hologram 407 based on the operation 418. In some examples, the operation 418 includes an iterative phase retrieval algorithm such as a Gerchberg-Saxton or similar algorithm. Such algorithms are used to determine the PSLM image plane that will result in the digital image 404 at the far field plane (at the SLM). In some examples, the operations 416 and 418 are offline operations performed before ongoing projector control operations (e.g., before operations of the SLM controller circuitry 210 and the PSLM controller circuitry 220). In some examples, the baseline hologram 407 may be stored in memory of the PSLM controller circuitry. For example, the baseline hologram 407 may be an example of the baseline hologram 230 stored in the memory 228 of the PSLM controller circuitry 220 in FIG. 2). The baseline hologram 407 is used as PSLM control data to generate the digital image 404 at the far field plane (e.g., at the SLM 170 or 170A in FIGS. 1, 2, and 3).

The sub-holograms 408 are the result of transforming the baseline hologram 407 to each target zone position using operation 420. In some examples, the operation 420 involves multiplying the baseline hologram 407 by respective brightness zone transforms. In the example of FIG. 4, the resulting sub-holograms 408 include sub-holograms 410A to 410L. Specially, sub-hologram 410A relates to zone position (1,1) of the target brightness zones 402. Sub-hologram 410B relates to zone position (1,2) of the target brightness zones 402. Sub-hologram 410C relates to zone position (1,3) of the target brightness zones 402. Sub-hologram 410D relates to zone position (1,4) of the target brightness zones 402. Sub-hologram 410E relates to position (2,1) of the target brightness zones 402. Sub-hologram 410F relates to position (2,2) of the target brightness zones 402. Sub-hologram 410G relates to position (2,3) of the target brightness zones 402. Sub-hologram 410H relates to position (2,4) of the target brightness zones 402. Sub-hologram 410I relates to position (3,1) of the target brightness zones 402. Sub-hologram 410J relates to position (3,2) of the target brightness zones 402. Sub-hologram 410K relates to position (3,3) of the target brightness zones 402. Sub-hologram 410L relates to position (3,4) of the target brightness zones 402. In the example of FIG. 4, 12 target zone positions are represented. In other examples, the number of target zone positions and respective sub-holograms may vary.

In some examples, the operation 420 is based on position shift parameters Aᵢ and Bᵢ. In the example of FIG. 4, the zone 406 is centered in the digital image 404. For the example of FIG. 4, the sub-hologram 410A is obtained using a negative Aᵢ to shift one zone up from a central zone position and a negative Bᵢ to shift 1.5 zones to the left from a central zone position. The sub-hologram 410B is obtained using a negative Aᵢ to shift one zone up from a central zone position and a negative Bᵢ to shift 0.5 zones to the left from a central zone position. The sub-hologram 410C is obtained using a negative Aᵢ to shift one zone up from a central zone position and a positive Bᵢ to shift 0.5 zones to the right from a central zone position. The sub-hologram 410D is obtained using a negative Aᵢ to shift one zone up from a central zone position and a positive Bᵢ to shift 1.5 zones to the right from a central zone position.

The sub-hologram 410E is obtained using a zeroed Aᵢ so there is no shift up or down from a central zone position and a negative Bᵢ to shift 1.5 zones to the left from a central zone position. The sub-hologram 410F is obtained using a zeroed Aᵢ so there is no shift up or down from a central zone position and a negative Bᵢ to shift 0.5 zones to the left from a central zone position. The sub-hologram 410G is obtained using a zeroed Aᵢ so there is no shift up or down from a central zone position and a positive Bᵢ to shift 0.5 zones to the right from a central zone position. The sub-hologram 410H is obtained using a zeroed Aᵢ so there is no shift up or down from a central zone position and a positive Bᵢ to shift 1.5 zones to the right from a central zone position.

The sub-hologram 410I is obtained using a positive Aᵢ to shift one zone down from a central zone position and a negative Bᵢ to shift 1.5 zones to the left from a central zone position. The sub-hologram 410J is obtained using a positive Aᵢ to shift one zone down from a central zone position and a negative Bᵢ to shift 0.5 zones to the left from a central zone position. The sub-hologram 410K is obtained using a positive Aᵢ to shift one zone down from a central zone position and a positive Bᵢ to shift 0.5 zones to the right from a central zone position. The sub-hologram 410L is obtained using a positive Aᵢ to shift one zone down from a central zone position and a positive Bᵢ to shift 1.5 zones to the right from a central zone position.

In the example of FIG. 4, the sub-hologram 410A relates to zone position (1,1) of the target brightness zones 402 and zone position (1,1) of the hologram image 414. The sub-hologram 410B relates to zone position (1,2) of the target brightness zones 402 and zone position (1,2) of the hologram image 414. The sub-hologram 410C relates to zone position (1,3) of the target brightness zones 402 and zone position (1,3) of the hologram image 414. The sub-hologram 410D relates to zone position (1,4) of the target brightness zones 402 and zone position (1,4) of the hologram image 414. The sub-hologram 410E relates to zone position (2,1) of the target brightness zones 402 and zone position (2,1) of the hologram image 414. The sub-hologram 410F relates to zone position (2,2) of the target brightness zones 402 and zone position (2,2) of the hologram image 414. The sub-hologram 410G relates to zone position (2,3) of the target brightness zones 402 and zone position (2,3) of the hologram image 414. The sub-hologram 410H relates to zone position (2,4) of the target brightness zones 402 and zone position (2,4) of the hologram image 414. The sub-hologram 410I relates to zone position (3,1) of the target brightness zones 402 and zone position (3,1) of the hologram image 414. The sub-hologram 410J relates to zone position (3,2) of the target brightness zones 402 and zone position (3,2) of the hologram image 414. The sub-hologram 410K relates to zone position (3,3) of the target brightness zones 402 and zone position (3,3) of the hologram image 414. The sub-hologram 410L relates to zone position (3,4) of the target brightness zones 402 and zone position (3,4) of the hologram image 414.

In some examples, the digital image 404 may have a zone 406 that is not centered. For example, the zone 406 may be in an upper left corner, an upper right corner, a lower left corner, a lower right corner, or another location. For each different position of the zone 406, the shift parameters Aᵢ and Bᵢ used to determine sub-holograms, such as the sub-holograms 408, would vary. If the zone 406 is bigger than a target zone size, the operation 420 may apply a first scaling factor (e.g., scale by a value less than 1) to reduce the zone size in the hologram image 414 that will result from each sub-hologram relative to the zone 406. If the zone 406 is smaller than a target zone size, the operation 420 may apply a second scaling factor (e.g., scale by a value less than 1) to increase the zone size in the hologram image 414 that will result from each sub-hologram relative to the zone 406.

In some examples, the operation 420 is an offline operation (before real-time projector control operations are performed) to reduce computation complexity during real-time projector control operations. In such examples, PSLM controller circuitry (e.g., the PSLM controller circuitry 220 in FIG. 2) may have more memory and less processing power. In other examples, the operation 420 is an online operation performed while real-time projector control operations are being performed. In such examples, PSLM controller circuitry (e.g., the PSLM controller circuitry 220 in FIG. 2) may have less memory and more processing power.

In some examples, the target hologram 412 combines the sub-holograms 408 based on the operation 422. In some examples, the operation 422 includes: selecting a portion of each of the sub-holograms 408 based on respective zone brightness levels; and combining the selected portions together to form the target hologram 412. In some examples, the size of each selected portion for each of the sub-holograms 408 is proportional to the respective brightness levels. For example, a sub-hologram related to a brightest zone of the hologram image 414 will have a larger portion selected versus a sub-hologram related to a less bright zone of the hologram image 414. To form the target hologram 412, 12 sub-hologram portions (1 for each of the sub-holograms 408) are combined. In some examples, combining sub-holograms involves adding the sub-hologram portions or tiles together. The resulting target hologram 412 includes the data for the PSLM that will result in the hologram image 414 at the SLM, including the different brightness levels for each of the zones.

To form the hologram image 414 from the target hologram 412, the operation 424 is performed. In some examples, the operation 424 includes providing the target hologram 412 to a PSLM (e.g., the PSLM 160 or 160A herein) and providing light from a light source (e.g., the light source 150 or 150A herein). In some examples, forming the hologram image 414 involves adjusting or setting the intensity of light from the light source to support the target brightness zones of hologram image 414.

In the example of FIG. 4, the digital image 404 and the hologram image 414 are considered to be in the image domain, which represents a visible image or related pixel data. In contrast, the baseline hologram 407, the sub-holograms 408, and the target hologram 412 are considered to be in the hologram domain, which represents hologram data. Such hologram data appears as random noise in the image domain and is used as control data for a PSLM. In other words, the pixel data for a PSLM is in the hologram domain, while the far field image at the SLM in in the image domain. In the image domain and/or the hologram domain mathematical operations may include frequency domain operations and/or spatial domain operations.

In the example of FIG. 4, applying the baseline hologram 407 to a PSLM results in a hologram image at the SLM equivalent to the digital image 404, where only zone 406 is illuminated. Applying the sub-hologram 410A to a PSLM results in a hologram image at the SLM with only zone position (1,1) illuminated. Applying the sub-hologram 410B to a PSLM results in a hologram image at the SLM with only zone position (1,2) illuminated. Applying the sub-hologram 410C to a PSLM results in a hologram image at the SLM with only zone position (1,3) illuminated. Applying the sub-hologram 410D to a PSLM results in a hologram image at the SLM with only zone position (1,4) illuminated. Applying the sub-hologram 410E to a PSLM results in a hologram image at the SLM with only zone position (2,1) illuminated. Applying the sub-hologram 410F to a PSLM results in a hologram image at the SLM with only zone position (2,2) illuminated. Applying the sub-hologram 410G to a PSLM results in a hologram image at the SLM with only zone position (2,3) illuminated. Applying the sub-hologram 410H to a PSLM results in a hologram image at the SLM with only zone position (2,4) illuminated. Applying the sub-hologram 410I to a PSLM results in a hologram image at the SLM with only zone position (3,1) illuminated. Applying the sub-hologram 410J to a PSLM results in a hologram image at the SLM with only zone position (3,2) illuminated. Applying the sub-hologram 410K to a PSLM results in a hologram image at the SLM with only zone position (3,3) illuminated. Applying the sub-hologram 410L to a PSLM results in a hologram image at the SLM with only zone position (3,4) illuminated. Applying the target hologram 412 to a PSLM results in the hologram image 414, where the different zones of the hologram image 414 have different brightness levels due to light being distributed differently to the different zones by the PSLM responsive to the target hologram 412.

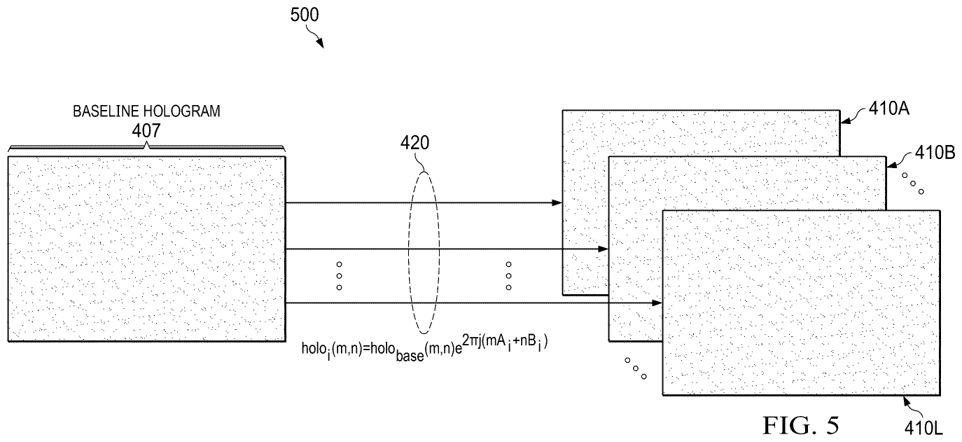

FIG. 5 is a diagram 500 representing transformation of a baseline hologram to sub-holograms in accordance with various examples. In the example of FIG. 5, the baseline hologram 407 is transformed to obtain the sub-holograms 410A to 410L based on the operation 420 described in FIG. 4. In some examples, the transformation of the baseline hologram 407 to obtain sub-holograms is based on holoᵢ(m, n)=holo_{base}(m, n)e^{2π(mA}^{ᵢ}^{+nB}^{ᵢ}⁾, where Aᵢ and Bᵢ are the position (or phase) shift parameters. In some examples, the baseline hologram 407 is given as holo_{base}(m, n), where m and n are the row and column numbers for each pixel in the hologram. Each of the sub-holograms 410A to 410L may be given as: holoᵢ(m, n)=holo_{base}(m, n)e^{2π(mA}^{ᵢ}^{+nB}^{ᵢ}⁾, where Aᵢ and Bᵢ are the position (or phase) shift parameters. As described in FIG. 4, the particular position shift parameter values may vary depending on the position of the zone 406 in the digital image 404. Other sub-holograms may similarly be determined using a respective position shift transform (sometimes referred to as a brightness zone transform herein).

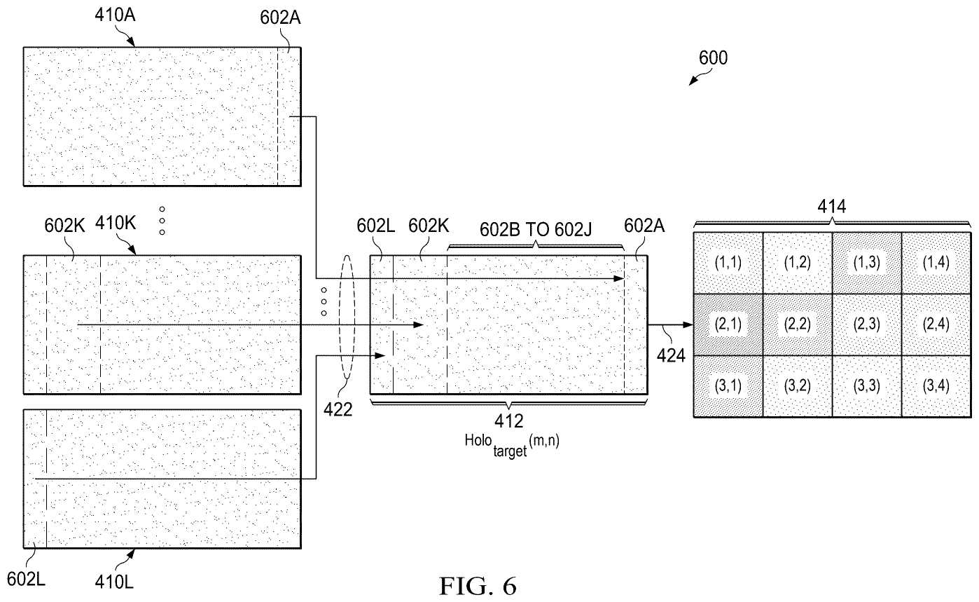

FIG. 6 is a diagram 600 representing tiling of sub-holograms to form a target hologram in accordance with various examples. The sub-holograms in FIG. 6 include the sub-holograms 410A to 410L described in FIGS. 4 and 5. The target hologram in FIG. 6 includes the target hologram 412 described in FIG. 4. For the example of FIG. 6, the operation 422 selects a respective portion or tile 602A to 602L for each of the sub-holograms 410A to 410L and combines the selected portions or tiles tile 602A to 602L to form the target hologram 412. The relative size of the respective portion or tile 602A to 602L for each of the sub-holograms 410A to 410L is proportional to the target brightness level for each of the zones in the hologram image 414. In some examples, the target hologram is given as: Holo_{target}(m,n), where m is pixel and n In different examples, the total number of sub-holograms used to form the target hologram 412 may vary depending on the total number of zones in the target brightness zones 402 and the resulting hologram image 414.

In the diagram 600, the sub-hologram 410A includes a respective tile (or portion) 602A, the sub-hologram 410K includes a respective tile 602K, and the sub-hologram 410L includes a respective tile 602L. Likewise, each of the sub-holograms 602B to 602J includes a respective tile. The size of each of the tiles 602A to 602L in the target hologram 412 determines the amount of power allocated to each respective zone in the hologram image 414. In the example of FIG. 6, vertical tiling is used to define the tiles 602A to 602L. In other examples, horizontal tiling, rectangular tiling, or other tiling options may be used to select portions of each of the sub-holograms 410A to 410L and the resulting target hologram 412. To form the hologram image 414 in the far field (e.g., at the surface or optical input 174 of the SLM 170), the target hologram 412 is provided to a PSLM such as the PSLM 160 in FIGS. 1 and 2, or the PSLM 160A in FIG. 3.

In some examples, the target hologram 412 is given as:

$${Holo}_{target} ( m , n ) = {\sum }_{i = 1}^{I} {mask}_{i} ( m , n ) hol {o}_{i} ( m , n ) , \qquad Equation ( 1 )$$

where i is a given zone, I is the total number of zones, holoᵢ(m, n) are the sub-holograms in the space defined by m and n (the row and column numbers for each pixel in the hologram), and maskᵢ(m, n) is given as:

$$Equation ( 2 ) .$$

$${mask}_{i} ( m , n ) = \{ \begin{matrix}1 in area where mask is to be extracted \\ 0 elsewhere\end{matrix} .$$

$$Equation ( 3 ) .$$

$$For i not equal to j , {\sum }_{i = 1} {\sum }_{j = 1} {mask}_{i} ( m , n ) {mask}_{j} ( m , n ) = 0.$$

$$Equation ( 4 )$$

$$Also , {power}_{i} = α {\sum }_{m = 1}^{M} {\sum }_{n = 1}^{N} {mask}_{i} ( m , n ) ,$$

where powerᵢ is the relative power directed to zone i, and α is a power scaling factor applied to each zone.

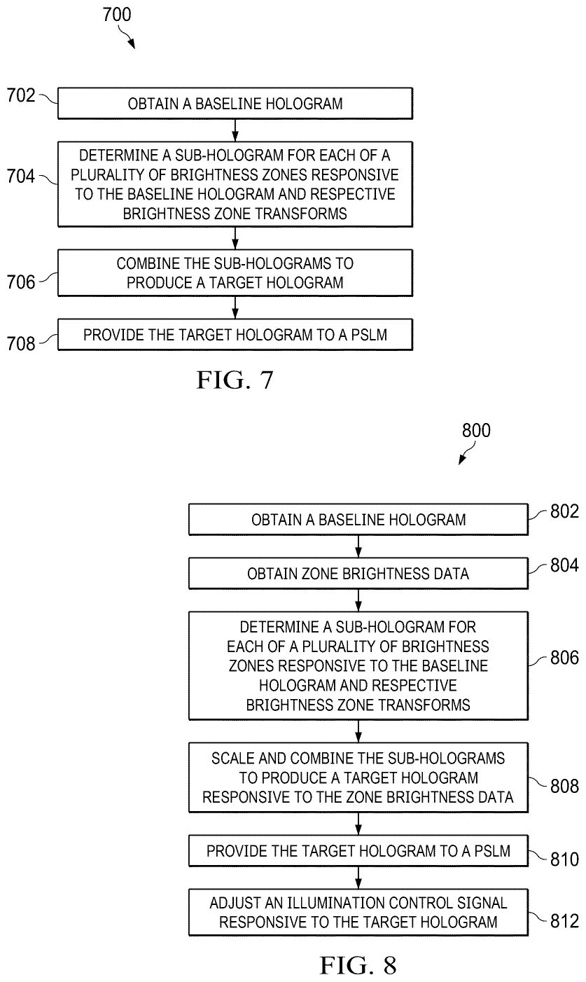

FIG. 7 is a flowchart showing a PSLM controller method 700 in accordance with various examples. The PSLM controller method 700 may be performed, for example, by the controller 102 in FIG. 1, the PSLM control circuitry 130 in FIG. 1, the PSLM control circuitry 220 in FIG. 2, or the controller 302 in FIG. 3. As shown, the PSLM controller method 700 includes obtaining a baseline hologram at block 702. In some examples, operations 416 and/or 418 described in FIG. 4 and related options may be used to obtain a baseline hologram at block 702. At block 704, a sub-hologram for each of a plurality of brightness zones is determined responsive to the baseline hologram and respective brightness zone transforms (see e.g., the diagram 500 of FIG. 5). In some examples, operation 420 described in FIGS. 4 and 5 and related options may be used to obtain sub-holograms at block 704. At block 706, the sub-holograms are combined to produce a target hologram (see e.g., the diagram 600 of FIG. 6). In some examples, operation 422 described in FIGS. 4 and 5 and related options may be used to produce a target hologram at block 706. At block 708, the target hologram is provided to a PSLM (e.g., the PSLM 160 of FIGS. 1 and 2, or the PSLM 160 in FIG. 3). In some examples, providing a target hologram to a PSLM at block 708 results in a hologram image (e.g., the hologram image 414 in FIG. 4) at the far field (e.g., the surface of the SLM), where the hologram image includes target brightness zones (e.g., the target brightness zones 402) with respective brightness levels.

FIG. 8 is a flowchart showing a projector control method 800 in accordance with various examples. The projector control method 800 may be performed, for example, by the controller 102 in FIG. 1, the SLM control circuitry 210, PSLM control circuitry 220, and the illumination control circuitry 232 in FIG. 2, or the controller 302 in FIG. 3. As shown, the projector control method 800 includes obtaining a baseline hologram at block 802. In some examples, operations 416 and/or 418 described in FIG. 4 and related options may be used to obtain a baseline hologram at block 802. At block 804, zone brightness data is obtained. In some examples, operation 416 described in FIG. 4 and related options may be used to obtain zone brightness data at block 804. At block 806, a sub-hologram for each of a plurality of brightness zones is determined responsive to the baseline hologram and respective brightness zone transforms (see e.g., the diagram 500 of FIG. 5). In some examples, operation 420 described in FIGS. 4 and 5 and related options may be used to obtain sub-holograms at block 806. At block 808, the sub-holograms are scaled and combined to produce a target hologram (see e.g., the diagram 600 of FIG. 6) responsive to the zone brightness data. In some examples, operation 422 described in FIGS. 4 and 5 and related options may be used to produce a target hologram at block 808. At block 810, the target hologram is provided to a PSLM (e.g., CS2 includes the target hologram). In some examples, providing a target hologram to a PSLM at block 810 results in a hologram image (e.g., the hologram image 414 in FIG. 4) at the far field (e.g., the surface of the SLM), where the hologram image includes target brightness zones (e.g., the target brightness zones 402) with respective brightness levels. At block 812, an illumination control signal (e.g., CS4 or related signals herein) may be adjusted responsive to the target hologram. In some examples, adjustment of the illumination control signal may be used to dynamically adjust a maximum brightness level during projector control operations. The light (adjusted or not) from the light source is applied to the PSLM, which directs the light to the SLM responsive to the target hologram to generate a hologram image at the surface of the SLM.

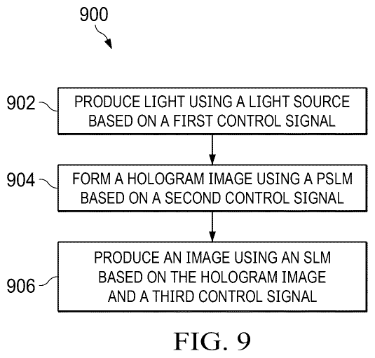

FIG. 9 is a flowchart showing a projector method 900 in accordance with various examples. As shown, the projector method 900 includes producing light using a light source (e.g., the light source 150 or 150A herein) based on a first control signal (e.g., CS3 herein) at block 902. At block 904, a hologram image is formed using a PSLM (e.g., the PSLM 160 or 160A herein) based on a second control signal (e.g., CS2 herein) and based on the light produced at block 902. At block 906, an image (e.g., the projected video 196 herein) is produced using an SLM (e.g., the SLM 170 or 170A herein) based on the hologram image and a third control signal (e.g., CS1 herein). In some examples, the projector method 900 includes focusing light via a focusing lens (e.g., the focusing lens 314 herein) between the light source and the PSLM. In some examples, the projector method 900 includes passing an image through a projection lens (e.g., the projection lens 324 herein).

In some examples, a system (e.g., the system 100 in FIG. 1, the system 200 in FIG. 2, or the projector 300 in FIG. 3) includes: an SLM (e.g., the SLM 170 in FIGS. 1 and 2, or the SLM 170A in FIG. 3) having a first array of pixels (e.g., the array of pixels 178 in FIG. 1); a PSLM (e.g., the PSLM 160 in FIGS. 1 and 2, or the PSLM 160A in FIG. 3) optically coupled to and illuminating the SLM, the PSLM having a second array of pixels (e.g., the array of pixels 168 in FIG. 1); and control circuitry (e.g., the controller 102 or related components in FIG. 1, the SLM control circuitry 210, the PSLM control circuitry 220, and the illumination control circuitry 232 in FIG. 2, or the controller 302 in FIG. 3) coupled to the SLM and PSLM.

The control circuitry is configured to: obtain a baseline hologram (e.g., the baseline hologram 407 in FIGS. 4 and 5); determine sub-holograms for a plurality of brightness zones (e.g., the sub-holograms 408 in FIG. 4, or related sub-holograms 410A to 410L in FIGS. 5 and 6) responsive to the baseline hologram and respective brightness zone transforms (see e.g., the transforms of the diagram 500 in FIG. 5). The control circuitry is also configured combine the sub-holograms to produce a target hologram (see e.g., the diagram 600 in FIG. 6); provide the target hologram to the PSLM; and provide control data to the SLM. In such examples, the SLM is configured to adjust the first array of pixels responsive to the control data. The is PSLM configured to adjust the second array of pixels responsive to the target hologram.

In some examples, the control circuitry is configured to: receive video data (e.g., the video data received at the first terminal 104 of the controller 102 in FIG. 1, or the video data received at the first terminal 204 of the SoC 202 in FIG. 2); produce pixel data (e.g., the pixel data at the second terminal 206 of the SoC 202 in FIG. 2) responsive to the video data; and produce zone brightness data (e.g., the zone brightness data at the third terminal 208 of the SoC 202 in FIG. 2) responsive to the video data.

In some examples, the control circuitry is further configured to: receive the pixel data; produce control data (e.g., CS1 herein) responsive to the pixel data; and provide the control data to the SLM. In some examples, the control circuitry is further configured to scale or select a portion of the sub-holograms responsive to the zone brightness data (see e.g., the diagram 600 of FIG. 6).

In some examples, the system includes: illumination control circuitry (e.g., the illumination control circuitry 140 in FIG. 1, or the illumination control circuitry 232 in FIG. 2) coupled to the control circuitry; and a light source (e.g., the light source 150 in FIGS. 1 to 3) coupled to the illumination control circuitry and optically coupled to the PSLM. In such examples, the control circuitry is further configured to produce an illumination control signal (e.g., CS4 herein) responsive to the target hologram and to transmit the illumination control signal to the illumination control circuitry. The illumination control circuitry is configured to control the light source based on the illumination control signal.

In some examples, the respective brightness zone transforms include multiplication of the baseline hologram by a phase function (see e.g., the transforms in the diagram 500 of FIG. 5). In some examples, combining the sub-holograms to form the target hologram includes tiling the sub-holograms horizontally or vertically (see e.g., the tiling in the diagram 600 of FIG. 6). In some examples, obtaining the baseline hologram comprises performing an iterative phase retrieval algorithm (e.g., a Gerchberg-Saxton algorithm or similar algorithm).

In some examples, a method includes: determining, by control circuitry (e.g., the controller 102 in FIG. 1, the SLM control circuitry 210, PSLM control circuitry 220, and the illumination control circuitry 232 in FIG. 2, or the controller 302 in FIG. 3) sub-hologram for a plurality of brightness zones (e.g., the sub-holograms 408 in FIG. 4); combining, by the control circuitry, the sub-holograms to produce a target hologram (see e.g., the diagram 600 in FIG. 6); and transmitting, by the control circuitry, the target hologram (e.g., the target hologram may be included with CS2 herein).

In some examples, the method includes: obtaining a baseline hologram (e.g., the baseline hologram 407 in FIGS. 4 and 5); and determining sub-holograms for the plurality of brightness zones responsive to the baseline hologram and respective brightness zone transforms (see e.g., the diagram 500 of FIG. 5). In some examples, the respective brightness zone transforms include multiplication of the baseline hologram by a respective phase function (e.g., multiplication by e^{2π(mA+nB)} as described for FIG. 5).

In some examples, the method includes: determining the baseline hologram based on an iterative phase retrieval algorithm (e.g., a Gerchberg-Saxton algorithm or similar algorithm); and storing the baseline hologram in a memory (e.g., the memory 228 in FIG. 2). In such examples, obtaining the baseline hologram includes retrieving the baseline hologram from the memory.

In some examples, the method includes: obtaining zone brightness data (e.g., based on operations of the controller 102 in FIG. 1, operations of the SoC 202 in FIG. 2, or operations of the controller 302 in FIG. 2); and scaling or tiling the sub-holograms responsive to the zone brightness data (see e.g., the diagram 600 in FIG. 6). In some examples, combining the sub-holograms to form the target hologram includes tiling the sub-holograms horizontally or vertically. In some examples, the method includes adjusting an illumination control signal (e.g., CS4 herein) responsive to the target hologram.

In some examples, a projector (e.g., the system 100 in FIG. 1, the system 200 in FIG. 2, or components of the projector 300 in FIG. 3) includes: a PSLM (e.g., the PSLM 160 in FIG. 1) having an array of pixels (e.g., the array of pixels 168 in FIG. 1; and a controller (e.g., the controller 102 in FIG. 1, the PSLM control circuitry 220 in FIG. 2, or the controller 302 in FIG. 3) coupled to the PSLM. The controller is configured to: obtain zone brightness data; obtain a baseline hologram; determine sub-holograms for a plurality of brightness zones responsive to the baseline hologram and the zone brightness data; combine the sub-holograms to produce a target hologram; and provide the target hologram to the PSLM, wherein the PSLM is configured to adjust the array of pixels based on the target hologram. In some examples, the baseline hologram may be precomputed and stored in memory to reduce real-time computation. In some examples, the controller is configured to produce an illumination control signal (e.g., CS4 herein) responsive to the target hologram. In some examples, the controller is configured to: determine each sub-hologram by multiplying the baseline hologram by a respective phase function; and scale each sub-hologram based on the zone brightness data. In some examples, the controller is configured to combine the sub-holograms to form the target hologram based on tiling the sub-holograms horizontally or vertically. In some examples, the controller includes an FPGA.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other examples, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated circuit. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter or, if the parameter is zero, a reasonable range of values around zero.

Modifications are possible in the described examples, and other examples are possible, within the scope of the claims.

1. A system comprising:
a spatial light modulator (SLM) having a first array of pixels;
a phase spatial light modulator (PSLM) optically coupled to and illuminating the SLM, the PSLM having a second array of pixels; and
control circuitry coupled to the SLM and PSLM, wherein the control circuitry is configured to:
obtain a baseline hologram;
determine sub-holograms for a plurality of brightness zones responsive to the baseline hologram and respective brightness zone transforms;
combine the sub-holograms to produce a target hologram;
provide the target hologram to the PSLM; and
provide control data to the SLM,
the SLM configured to adjust the first array of pixels responsive to the control data, and
the PSLM configured to adjust the second array of pixels responsive to the target hologram.

2. The system of claim 1, wherein the control circuitry is configured to:
receive video data;
produce pixel data responsive to the video data; and
produce zone brightness data responsive to the video data for the plurality of brightness zones.

3. The system of claim 2, wherein the control circuitry is further configured to:
receive the pixel data;
produce the control data responsive to the pixel data; and
provide the control data to the SLM.

4. The system of claim 2, wherein the control circuitry is further configured to:
scale the sub-holograms responsive to the zone brightness data.

5. The system of claim 1, further comprising:
illumination control circuitry coupled to the control circuitry; and
a light source coupled to the illumination control circuitry and optically coupled to the PSLM,
wherein the control circuitry is further configured to produce an illumination control signal responsive to the target hologram and to transmit the illumination control signal to the illumination control circuitry, and
the illumination control circuitry is configured to control the light source based on the illumination control signal.

6. The system of claim 1, wherein the respective brightness zone transforms include multiplication of the baseline hologram by a phase function.

7. The system of claim 1, wherein combining the sub-holograms to form the target hologram includes tiling the sub-holograms horizontally or vertically.

8. The system of claim 1, wherein obtaining the baseline hologram comprises performing an iterative phase retrieval algorithm.

9. A method comprising:
determining, by control circuitry, sub-holograms for a plurality of brightness zones;
combining, by the control circuitry, the sub-holograms to produce a target hologram; and
transmitting, by the control circuitry, the target hologram.

10. The method of claim 9, further comprising:
obtaining a baseline hologram; and
determining the sub-holograms of the plurality of brightness zones responsive to the baseline hologram and respective brightness zone transforms.

11. The method of claim 10, wherein the respective brightness zone transforms include multiplication of the baseline hologram by a phase function.

12. The method of claim 10, further comprising:
determining the baseline hologram based on an iterative phase retrieval algorithm; and
storing the baseline hologram in a memory, wherein obtaining the baseline hologram includes retrieving the baseline hologram from the memory.

13. The method of claim 9, further comprising:
obtaining zone brightness data; and
scaling the sub-holograms responsive to the zone brightness data.

14. The method of claim 9, wherein combining the sub-holograms to form the target hologram includes tiling the sub-holograms horizontally or vertically.

15. The method of claim 9, further comprising adjusting an illumination control signal responsive to the target hologram.

16. A projector comprising:
a phase spatial light modulator (PSLM) having an array of pixels; and
a controller coupled to the PSLM, the controller configured to:
obtain zone brightness data;
obtain a baseline hologram;
determine sub-holograms for fa plurality of brightness zones responsive to the baseline hologram and the zone brightness data;
combine the sub-holograms to produce a target hologram; and
provide the target hologram to the PSLM, wherein the PSLM is configured to adjust the array of pixels based on the target hologram.

17. The projector of claim 16, wherein the controller is configured to produce an illumination control signal responsive to the target hologram.

18. The projector of claim 16, wherein the controller is configured to:
determine each sub-hologram by multiplying the baseline hologram by a respective phase function; and
scale each sub-hologram based on the zone brightness data.

19. The projector of claim 18, wherein the controller is configured to combine the sub-holograms to form the target hologram based on tiling the sub-holograms horizontally or vertically.

20. The projector of claim 16, wherein the controller includes a field-programmable gate array (FPGA).
